(19) United States
(12) Patent Application Publication
(10) Pub. No.: US 2006/0292515 A1
(43) Pub. Date: Dec. 28, 2006

(54) Heat treatment apparatus

(75) Inventors: Akihiro Hisai, Kyoto (JP); Shigehiro Goto, Kyoto (JP)

Correspondence Address: OSTROLENK FABER GERB & SOFFEN, 1180 AVENUE OF THE AMERICAS, NEW YORK, NY, 100368403, US

(73) Assignee: Dainippon Screen Mfg. Co., Ltd.

(21) Appl. No.: 11/436,739

(22) Filed: May 16, 2006

(30) Foreign Application Priority Data
May 17, 2005 (JP) 2005-144240

(51) Int. Cl. F27D 15/02

(52) U.S. Cl. 432/77

(57) ABSTRACT

A heat treatment apparatus has a heat pipe structure, and includes a hollow heat-treating plate, and a temperature sensor for measuring temperatures of the heat-treating plate. A pair of operating fluid storage portions are formed below a hollow portion of the heat-treating plate. An operating fluid is stored in these operating fluid storage portions, and heaters are provided for heating the operating fluid. This heat treatment apparatus further includes a pair of operating fluid passages extending between the hollow portion and operating fluid storage portions of the heat-treating plate. At least a portion of each operating fluid passage lying above the surface of the operating fluid stored in the operating fluid storage portions are shaped to have an angle of inclination with respect to the horizontal.

### BACKGROUND OF THE INVENTION

1. Field of the Invention

This invention relates to a heat treatment apparatus with a heat-treating plate for heating substrates such as semiconductor wafers, glass substrates for liquid crystal display panels or mask substrates for use in semiconductor manufacturing apparatus.

2. Description of the Related Art

Such a heat treatment apparatus is disclosed in Japanese Unexamined Patent Publication No. 2003-297738, for example.

The apparatus described in this publication includes a support table in the form of a housing having an inner space serving as a working area of an operating fluid in a heat pipe structure, a heating device for heating the support table through the heat pipe structure, and a cooling device disposed in the inner space of the housing.

With the apparatus described in the above publication, the operating fluid of the heat pipe structure can be cooled by the cooling device disposed inside the housing. As a result, the support table is cooled quickly.

The above apparatus has a drawback that, considering a positional relationship between the cooling device and rims for reinforcing the inner space of the housing, it is actually difficult to arrange the cooling device in the inner space of the housing.

With this apparatus, when cooling the support table, the vapor of the operating fluid and the operating fluid resulting from condensation by cooling in the housing flow in indefinite directions, and generate complicated convection currents in the housing. It is therefore difficult to cool the support table, i.e. the substrate support surface, smoothly.

### SUMMARY OF THE INVENTION

The object of this invention, therefore, is to provide a heat treatment apparatus capable of cooling a heat-treating plate smoothly.

The above object is fulfilled, according to this invention, by a heat treatment apparatus for heating a substrate, comprising a heat-treating plate for heat-treating the substrate as placed on or adjacent a surface thereof, the heat-treating plate having a hollow portion for transferring heat to the surface, an operating fluid storage portion communicating with the hollow portion for storing an operating fluid, and a heating device for heating and evaporating the operating fluid; and an operating fluid passage interconnecting the hollow portion and the operating fluid storage portion, at least a portion of the operating fluid passage lying above a surface of the operating fluid stored in the operating fluid storage portion being shaped to have an angle of inclination with respect to a horizontal plane.

With this heat treatment apparatus, currents of vapor of the operating fluid can be set to a fixed direction, thereby cooling the heat-treating plate smoothly. At least the portion of the operating fluid passage lying above the surface of the operating fluid stored in the operating fluid storage portion is shaped to have an angle of inclination with respect to a horizontal plane. This feature can prevent the operating fluid condensed by cooling from stagnating in the operating fluid passage.

In a preferred embodiment, the heat treatment apparatus further comprises a cooling mechanism for cooling the operating fluid passage.

With this construction, the vapor of the operating fluid may be cooled inside the operating fluid passage, and currents of the vapor of the operating fluid can be set to a fixed direction with ease.

The operating fluid passage may have a hydrophilic inner surface.

The above cooling mechanism may include a plate surrounding the operating fluid passage, a cooling fluid channel disposed in the plate, and a cooling fluid source for supplying a cooling fluid to the channel.

Other features and advantages of this invention will be apparent from the following detailed description of the embodiments of the invention.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a schematic side view of a heat treatment apparatus in a first embodiment of the invention;

FIG. 2 is a schematic plan view of the heat treatment apparatus in the first embodiment;

FIG. 3 is a block diagram of a principal electrical structure of the heat treatment apparatus in the first embodiment;

FIG. 4 is a plan view of a cooling plate;

FIG. 5 is a flow chart showing an operation for cooling a heat-treating plate in the first embodiment;

FIG. 6 is a schematic side view of a heat treatment apparatus in a second embodiment of the invention;

FIG. 7 is a block diagram of a principal electrical structure of the heat treatment apparatus in the second embodiment; and

FIG. 8 is a flow chart showing an operation for cooling a heat-treating plate in the second embodiment.

### DESCRIPTION OF THE PREFERRED EMBODIMENTS

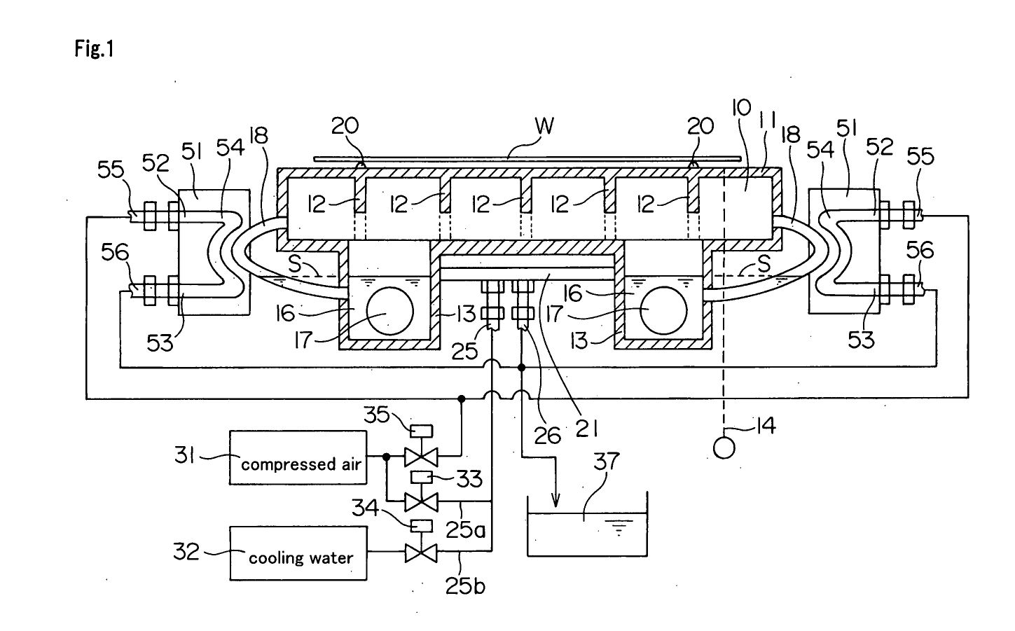

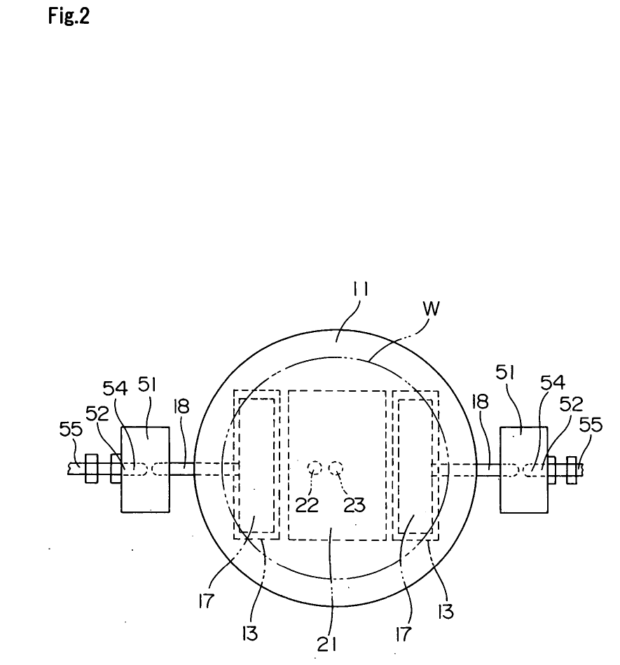

An embodiment of this invention will be described hereinafter with reference to the drawings. FIG. 1 is a schematic side view of a heat treatment apparatus in a first embodiment of the invention. FIG. 2 is a schematic plan view of the heat treatment apparatus. This heat treatment apparatus employs a heat pipe structure for enhancing the uniformity of temperature distribution over a substrate surface with a reduced heat capacity. The apparatus includes a heat-treating plate 11 of hollow structure, and a temperature sensor 14 for measuring the temperature of the heat-treating plate 11.

This heat-treating plate 11 serves to heat-treat a substrate or wafer W placed above the plate 11. The heat-treating plate 11 has a hollow cylindrical structure formed, for example, of a metal having an excellent heat-conducting characteristic, such as aluminum. The heat-treating plate 11 has three balls 20 arranged on the surface thereof, which are formed of a low heat conduction material such as alumina. The balls 20 have tops thereof slightly protruding from the surface of the heat-treating plate 11. Thus, the wafer W is heated as placed on and supported by the balls 20 of the heat-treating plate 11 such that a minute space called a proximity gap is formed between the lower surface of wafer W and the upper surface of heat-treating plate 11.

Instead of the above arrangement, the wafer W may be placed in direct contact with the upper surface of heat-treating plate 11.

The heat-treating plate 11 has an inner space decompressed because of the heat pipe structure, and including a plurality of reinforcing rims 12. A pair of operating fluid chambers 13 are formed below the inner space or hollow space 10 of the heat-treating plate 11. The operating fluid chambers 13 store an operating fluid 16 such as water. Heaters 17 are disposed in the operating fluid chambers 13 for heating the operating fluid 16.

The heat treatment apparatus further includes a pair of operating fluid passages 18 extending between the hollow space 10 and the respective operating fluid chambers 13 of the heat-treating plate 11. The portion of each operating fluid passage 18 lying above the surface S of the operating fluid stored in the operating fluid chambers 13 is shaped to have always an angle of inclination with respect to the horizontal.

The inner surface of each operating fluid passage 18 is formed of metal such as copper. Preferably, the inner surface is made hydrophilic by UV irradiation or blasting to allow the operating fluid to flow through easily.

In this heat treatment apparatus, the operating fluid 16 is heated by the heaters 17, and vapor of the operating fluid 16 moves through the hollow space 10 of the heat-treating plate 11 to transfer of the latent heat of vaporization to the heat-treating plate 11, thereby heating the heat-treating plate 11. The vapor of the operating fluid 16 having transferred the latent heat of vaporization to the heat-treating plate 11 is condensed to become the operating fluid 16 again to be collected in the operating fluid chambers 13 through the operating fluid passages 18.

This heat treatment apparatus collects the operating fluid 16 in the operating fluid chambers 13 through the operating fluid passages 18 whose portions lying above the surface S of the operating fluid 16 stored in the operating fluid chambers 13 always have an angle of inclination with respect to the horizontal. Thus, the convection currents generated by the vapor of operating fluid 16, and the operating fluid 16 resulting from condensation, may be set to a fixed direction in each operating fluid passage 18. The heat-treating plate 11 can thereby be cooled smoothly. The operating fluid resulting from condensation by the cooling always flows down the portion of each operating fluid passage 18 lying above the surface S of the operating fluid in the operating fluid chambers 13. This prevents stagnation of the operating fluid resulting from condensation by the cooling.

The heat treatment apparatus is required to cool the heat-treating plate 11 forcibly and quickly in order to lower the temperature for heat-treating the wafer W below a predetermined temperature immediately before treatment in accordance with the type of photoresist or other conditions. To meet this requirement, the heat treatment apparatus includes a cooling plate 21 disposed on the lower surface of the heat-treating plate 11 between the pair of operating fluid chambers 13.

In order to make a fine adjustment of the temperature of heat-treating plate 11, it is effective to cool of the heat-treating plate 11 forcibly but slowly. For this purpose, the heat treatment apparatus includes an auxiliary cooling plate 51 for cooling each operating fluid passage 18.

The constructions of the cooling plate 21 and auxiliary cooling plates 51 will be described in detail hereinafter.

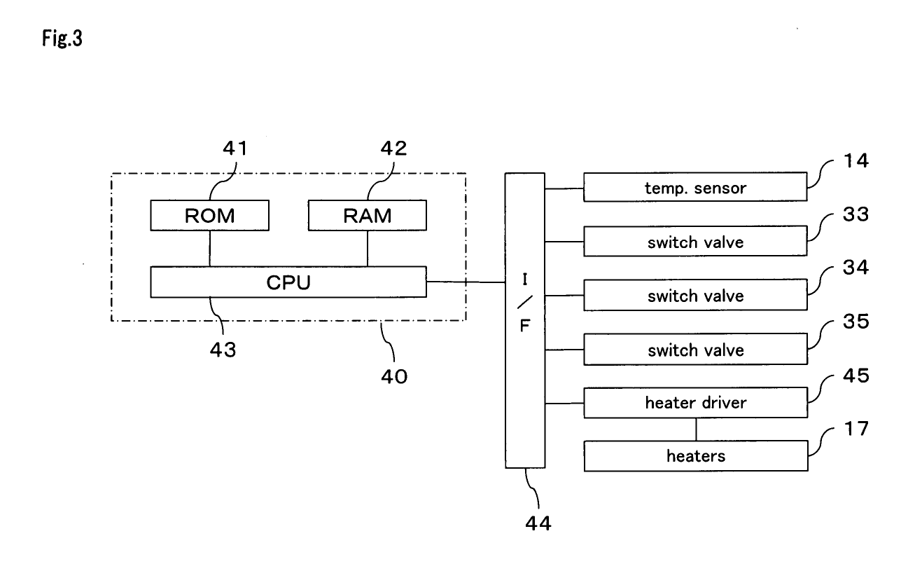

A principal electrical structure of the heat treatment apparatus according to this invention will be described next. FIG. 3 is a block diagram of a principal electrical structure of the heat treatment apparatus in the first embodiment.

This heat treatment apparatus includes a controller 40 having a ROM 41 for storing an operating program necessary for controlling the apparatus, a RAM 42 for temporarily storing data in time of control, and a CPU 43 for performing logic operations. The controller 40 is connected through an interface 44 to the temperature sensor 14, a switch valve 33, a switch valve 34 and a switch valve 35. The controller 40 is connected also to a heater driver 45 for driving the heaters 17 noted hereinbefore.

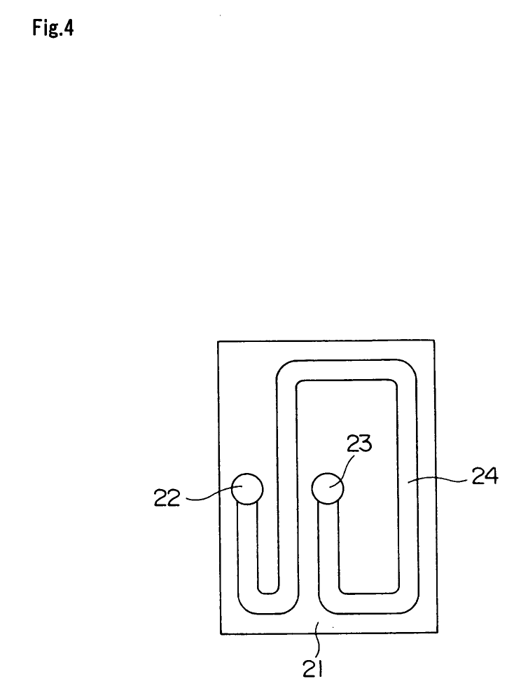

Next, the construction of the cooling plate 21 will be described. FIG. 4 is a plan view of the cooling plate 21.

The cooling plate 21 is formed of two metal plates of high thermal conductivity joined together. A cooling fluid channel 24 is formed in the mating surfaces. The cooling fluid channel 24 has an inlet port 22 formed at one end thereof, and an outlet port 23 at the other end. The channel 24 meanders from the inlet port 22 to the outlet port 23 in order to provide an increased passage length.

As shown in FIG. 1, a supply pipe 25 attached to the inlet port 22 branches into two supply pipes 25a and 25b. One branch supply pipe 25b is connected to a cooling water source 32 through the switch valve 34. The other branch supply pipe 25a is connected to a source 31 of compressed air serving as a cooling gas, through a switch valve 33. On the other hand, a discharge pipe 26 attached to the outlet port 23 is connected to a drain 37 open to the atmosphere.

Cooling water may be mere water, or may be a different coolant.

Next, the construction of the auxiliary cooling plates 51 will be described.

As shown in FIGS. 1 and 2, each auxiliary cooling plate 51 is formed of two metal plates of high thermal conductivity joined together. A cooling fluid channel 54 is formed in the mating surfaces. Each auxiliary cooling plate 51 has one of the operating fluid passages 18 extending therethrough. The cooling fluid channel 54 has an inlet port 52 formed at one end thereof, and an outlet port 53 at the other end. The channel 54 extends from the inlet port 52 to the outlet port 53 in a way to surround the operating fluid passage 18.

As shown in FIG. 1, a supply pipe 55 attached to the inlet port 52 is connected to the compressed air source 31 through the switch valve 35. On the other hand, a discharge pipe 56 attached to the outlet port 53 is connected to the drain 37 open to the atmosphere.

In the heat treatment apparatus having the above construction, for lowering the temperature for heat-treating the wafer W below the predetermined temperature immediately before treatment, the heat-treating plate 11 is cooled quickly by circulating the cooling water supplied from the cooling water source 32 through the cooling fluid channel 24. The cooling water used in cooling the heat-treating plate 11 is discharged to the drain 37 open to the atmosphere.

When the cooling water remains in the cooling water channel 24 after this cooling operation, the cooling water in the channel 24 will boil by being heated to a temperature at or above the boiling point in time of heating treatment of the wafer W that follows. This results in an uneven temperature of the heat-treating plate 11 or vibration of the heat-treating plate 11, thereby adversely influencing the treatment of the wafer W. To avoid such an inconvenience, this heat treatment apparatus circulates compressed air supplied from the compressed air source 31 through the cooling fluid channel 24 after supplying the cooling water to the channel 24 to lower the temperature of the heat-treating plate 11 quickly.

Further, this heat treatment apparatus, with the operating fluid passages 18 and auxiliary cooling plates 51, can cool the vapor of operating liquid 16 slowly in the operating fluid passages 18. This enables a fine adjustment of the temperature of the heat-treating plate 11. It is also possible to set currents of the vapor of operating fluid 16 to a fixed direction easily. Thus, the heat-treating plate 11 for heat-treating the wafer W may be cooled smoothly.

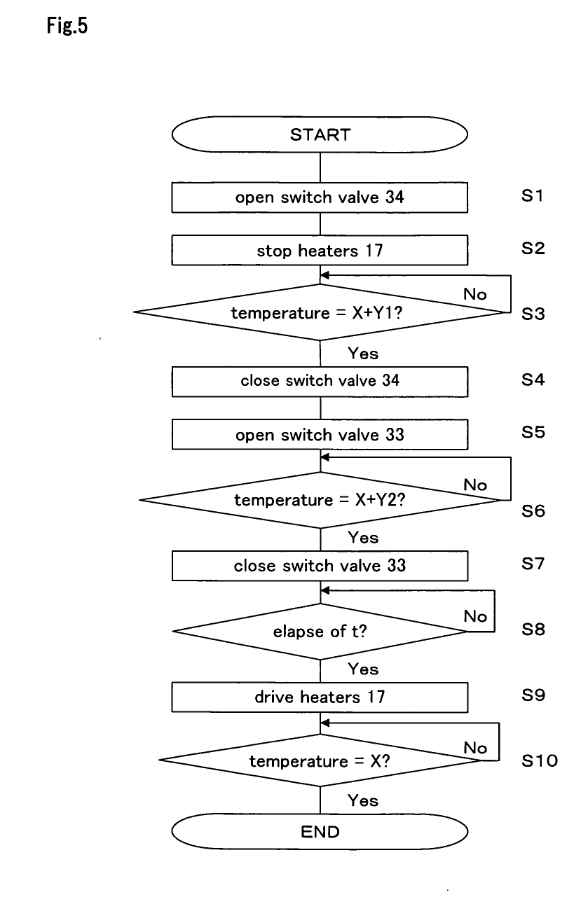

Next, an operation of the above heat treatment apparatus for cooling the heat-treating plate 11 to change the temperature for treating the wafer W to a new set temperature X lower than an immediately preceding temperature will be described. FIG. 5 is a flow chart showing an operation for cooling the heat-treating plate 11 in the first embodiment of the invention.

When the heat-treating plate 11 is set to a temperature for heat-treating wafers W of a certain lot, this temperature of the heat-treating plate 11 may be changed to the set temperature X in order to heat-treat wafers W of a different lot successively. In such a case, the following control operation is carried out to cool the heat-treating plate 11 by using the cooling plate 21 and auxiliary cooling plates 51.

First, the controller 40 opens the switch valve 34 to supply cooling water from the cooling water source 32 to the cooling fluid channel 24 of the cooling plate 21 (step S1). As a result, the heat-treating plate 11 is forcibly cooled by action of the cooling water, and its temperature is lowered quickly.

The switch valve 35 has been open, and compressed air is constantly supplied from the compressed air source 31 to the channels 54 of the auxiliary cooling plates 51. It is therefore possible to adjust the temperature of the heat-treating plate 11 only by executing the following steps S2 through S10. That is, the temperature of the heat-treating plate 11 can be adjusted only by controlling the heating by the heaters 17 and controlling supply of the cooling fluid to the cooling plate 21, without controlling the supply of compressed air to the auxiliary cooling plates 51. According to this heat treatment apparatus, therefore, the temperature adjustment of the heat-treating plate 11 is controlled in a simple way.

In parallel with the above, the heating control of the heaters 17 by the heater driver 45 is stopped (step S2). That is, the controller 40 outputs a command to the heater driver 45 to stop all control action for controlling the heaters 17.

The controller 40 monitors detection values from the temperature sensor 14 indicating temperatures of the heat-treating plate 11, and determines whether the temperature of the heat-treating plate 11 has reached a temperature higher than the new set temperature X by Y1 (step S3).

When the temperature of the heat-treating plate 11 has reached the temperature higher than the new set temperature X by Y1, the controller 40 closes the switch valve 34 to stop the supply of cooling water (step S4).

In parallel with this, the controller 40 opens the switch valve 33 to supply compressed air from the compressed air source 31 into the cooling fluid channel 24 of the cooling plate 21 (step S5). As a result, the cooling water is discharged from the cooling fluid channel 24, and the heat-treating plate 11 is cooled slowly by the action of compressed air.

When the temperature of the heat-treating plate 11 reaches a temperature higher than the new set temperature X by Y2, the controller 40 closes the switch valve 33 to stop the supply of compressed air (step S7). As a result, the heat-treating plate 11 is cooled by the auxiliary cooling plates 51 and heat radiation.

In this state, the operation waits for elapse of a fixed delay time t (step S8).

Upon lapse of the delay time t, the heater driver 45 starts the heating control of the heaters 17 (step S9). That is, the controller 40 outputs a command to the heater driver 45 to resume the control action for controlling the heaters 17.

When the temperature of the heat-treating plate 11 reaches the set temperature X (step S10), the cooling operation is ended.

The above delay time t is set for the following reason. In this heat treatment apparatus, the heater driver 45 uses PID control, for example, and the temperature of the heat-treating plate 11 is brought to the set temperature by controlling the heating operation of the heaters 17 based on the temperature of the heat-treating plate 11 measured at intervals of time. Various factors are set for the PID control with the condition that the heat-treating plate 11 cools in a usual state.

However, where, as in the heat treatment apparatus according to this embodiment, the heat-treating plate 11 is forcibly cooled by cooling water and compressed air, the heater driver 45 controls the heaters 17 by taking the cooling rate in time of the forced cooling into account. This brings about the problem of overshooting the new set temperature X.

In order to prevent this problem, this embodiment sets the fixed delay time t noted above. Since the forced cooling of the cooling plate 21 does not take place during the delay time t, the heat-treating plate 11 is cooled slowly by the auxiliary cooling plates 51 and heat radiation. Thus, temperature variations of the heat-treating plate 11 promptly settle to the temperature X with no overshoot.

The above-noted temperature Y2 for stopping the cooling operation, preferably, is determined from equation Y2=aX+b, where a and b are constants. This is because it is experimentally known that, when the heat-treating plate 11 is cooled with a gas such as compressed air, the higher set temperature X causes the heat-treating plate 11 to be cooled at the higher rate, and the rate is proportional to the set temperature.

The above delay time t corresponds to a time required for the cooling rate of the heat-treating plate 11 to shift from a state influenced by the forced cooling to a usual state. This delay time t can be experimentally determined by taking into account the heat capacity of the heat-treating plate 11, for example.

In the heat treatment apparatus having the above construction, cooling water is first used to cool the heat-treating plate 11, whereby the heat-treating plate 11 is cooled quickly. Subsequently, compressed air is used to cool the heat-treating plate 11 slowly. Thus, the operation for cooling the heat-treating plate 11 can attain the set temperature promptly with no overshoot.

At this time, the cooling water first supplied into the cooling fluid channel 24 and remaining in the channel 24 is discharged from this channel 24 by the compressed air subsequently supplied into the cooling fluid channel 24. This arrangement can effectively prevent a phenomenon in which the cooling water remaining in the cooling fluid channel 24 boils by being heated to a temperature at or above the boiling point in time of heating treatment of the wafer W.

Further, this heat treatment apparatus cools the heat-treating plate 11 still more slowly by using the auxiliary cooling plates 51. Thus, the temperature of heat-treating plate 11 can be adjusted minutely.

The heat treatment apparatus in the first embodiment described above uses cooling water to cool the heat-treating plate 11 quickly, and thereafter uses compressed air to cool the heat-treating plate 11 slowly. However, compressed air may be used only for discharging the cooling water remaining in the cooling fluid channel 24.

In the heat treatment apparatus in the first embodiment described above, the auxiliary cooling plates 51 are connected only to the compressed air source 31. Instead, the auxiliary cooling plates 51 may be connected also to the cooling water source 32 as is the cooling plate 21. In this case, since the heat-treating plate 11 can be cooled also by the auxiliary cooling plates 51 using cooling water, the heat-treating plate 11 can be cooled at a further increased rate.

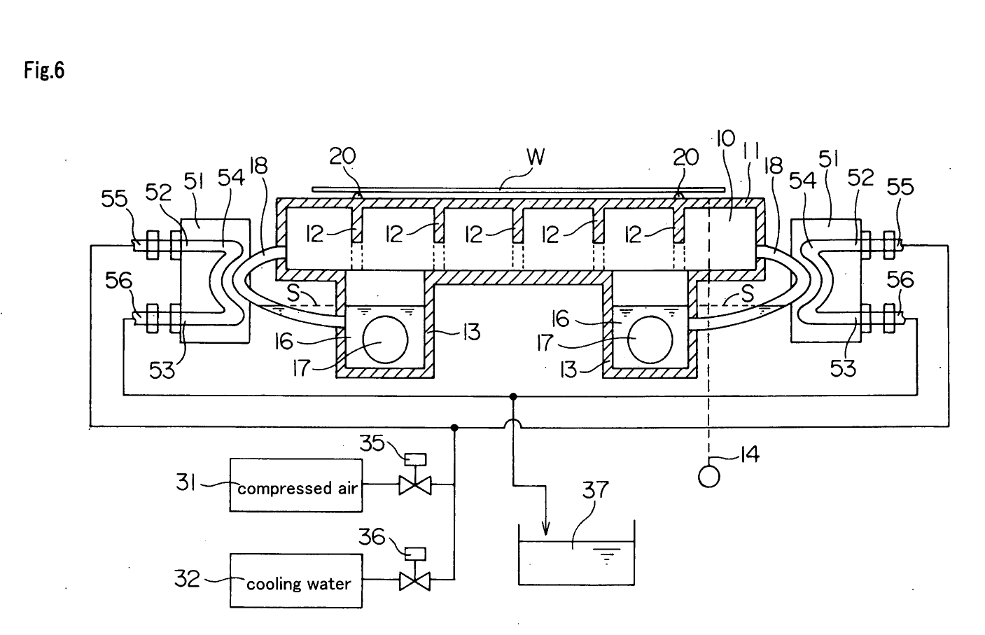

Next, another embodiment of this invention will be described with reference to the drawings. FIG. 6 is a schematic side view of a heat treatment apparatus in a second embodiment of the invention.

The heat treatment apparatus in the first embodiment includes the cooling plate 21. The heat treatment apparatus in the second embodiment differs from the heat treatment apparatus in the first embodiment in that this apparatus does not include the cooling plate 21. In the heat treatment apparatus in the second embodiment, for a high-speed cooling of the heat-treating plate 11, the supply pipe 55 attached to the inlet port 52 formed in each auxiliary cooling plate 51 is connected to the compressed air source 31 through the switch valve 35, and to the cooling water source 32 through a switch valve 36.

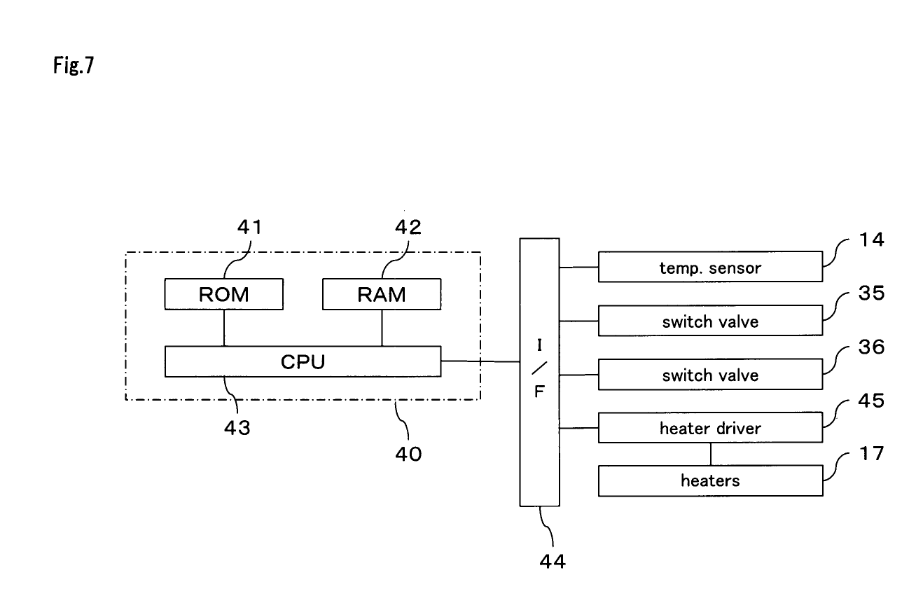

FIG. 7 is a block diagram showing a principal electrical structure of the heat treatment apparatus in the second embodiment of this invention.

The heat treatment apparatus in the second embodiment includes, as does the heat treatment apparatus in the first embodiment, a controller 40 having a ROM 41 for storing an operating program necessary for controlling the apparatus, a RAM 42 for temporarily storing data in time of control, and a CPU 43 for performing logic operations. The controller 40 in the second embodiment is connected through an interface 44 to the temperature sensor 14, switch valves 35 and 36, and a heater driver 45 for driving the heaters 17.

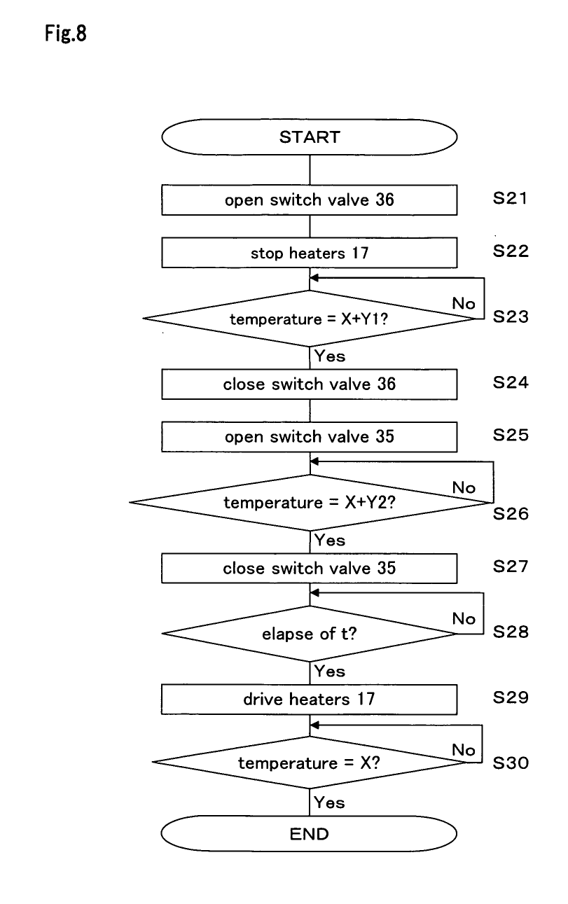

Next, an operation of the heat treatment apparatus in the second embodiment for cooling the heat-treating plate 11 to change the temperature for treating a wafer W to a new set temperature X lower than an immediately preceding temperature will be described. FIG. 8 is a flow chart showing an operation for cooling the heat-treating plate 11 in the second embodiment of the invention.

When the heat-treating plate 11 is changed to the new set temperature X, the controller 40 first opens the switch valve 36 to supply cooling water from the cooling water source 32 to the channels 54 of the auxiliary cooling plates 51 (step S21). As a result, the operating liquid 16 in the operating fluid passages 18 is cooled by action of the cooling water. This cools the heat-treating plate 11 rapidly and quickly to a reduced temperature.

In parallel with the above, the heating control of the heaters 17 by the heater driver 45 is stopped (step S22). That is, the controller 40 outputs a command to the heater driver 45 to stop all control action for controlling the heaters 17.

The controller 40 monitors detection values from the temperature sensor 14 indicating temperatures of the heat-treating plate 11, and determines whether the temperature of the heat-treating plate 11 has reached a temperature higher than the new set temperature X by Y1 (step S23).

When the temperature of the heat-treating plate 11 has reached the temperature higher than the new set temperature X by Y1, the controller 40 closes the switch valve 36 to stop the supply of cooling water (step S24).

In parallel with this, the controller 40 opens the switch valve 35 to supply compressed air from the compressed air source 31 into the channels 54 of the auxiliary cooling plates 51 (step S25). As a result, the cooling water is discharged from the channels 54, and the operating liquid 16 in the operating fluid passages 18 is cooled slowly. This cools the heat-treating plate 11 gently and slowly to a reduced temperature.

Then, checking is made whether the temperature of the heat-treating plate 11 has reached a temperature higher than the new set temperature X by Y2 (step S26).

When the temperature of the heat-treating plate 11 has reached the temperature higher than the new set temperature X by Y2, the controller 40 closes the switch valve 35 to stop the supply of compressed air (step S27). As a result, the heat-treating plate 11 is cooled only by heat radiation therefrom.

In this state, the operation waits for elapse of a fixed delay time t (step S28).

Upon lapse of the delay time t, the heater driver 45 starts the heating control of the heaters 17 (step S29). That is, the controller 40 outputs a command to the heater driver 45 to resume the control action for controlling the heaters 17.

When the temperature of the heat-treating plate 11 reaches the set temperature X (step S30), the cooling operation is ended.

The heat treatment apparatus in the second embodiment uses cooling water to cool the heat-treating plate 11 quickly, and thereafter uses compressed air to cool the heat-treating plate 11 slowly. However, compressed air may be used only for discharging the cooling water remaining in the channels 54.

In the heat treatment apparatus in the first and second embodiments described hereinbefore, the channel 24 and channels 54 are connected to the drain 37 open to the atmosphere. Thus, even when cooling water boils in the channel 24 or channels 54 due to a malfunction of the apparatus, the pressure in time of boiling can be released from the drain 37 open to the atmosphere. In this way, it is possible to preclude a danger of the pressure within the channel 24 or channels 54 increasing sharply and causing an explosion or the like.

In the first and second embodiments described hereinbefore, water is used as the cooling fluid. Compared with the case of using a chemical agent, water is available at low cost and disposable at low cost.

The first and second embodiments described hereinbefore has the switch valve 34 between the cooling water source 32 and cooling plate 21, and the switch valve 36 between the cooling water source 32 and auxiliary cooling plates 51. These switch valves may be replaced with flow regulating valves for adjusting flow rates of cooling water supplied to the channel 24 and channels 54. When this construction is employed, it is possible to change the rate of cooling the heat-treating plate 11.

The first and second embodiments described hereinbefore may include an air cooling device between the compressed air source 31 and cooling plate 21 or auxiliary cooling plates 51, or for the compressed air source 31 itself.

Each of the first and second embodiments described hereinbefore includes two operating fluid passages 18. The number of operating fluid passages 18 may be one, three or more.

It is desirable that the air supplied from the compressed air source 31 is dry air in order to prevent the cooling water from remaining in the channel 24 or channels 54.

This invention may be embodied in other specific forms without departing from the spirit or essential attributes thereof and, accordingly, reference should be made to the appended claims, rather than to the foregoing specification, as indicating the scope of the invention.

This application claims priority benefit under 35 U.S.C. Section 119 of Japanese Patent Application No. 2005-144240 filed in the Japanese Patent Office on May 17, 2005, the entire disclosure of which is incorporated herein by reference.

What is claimed is:

1. A heat treatment apparatus for heating a substrate, comprising:
a heat-treating plate for heat-treating the substrate as placed on or adjacent a surface thereof, said heat-treating plate having a hollow portion for transferring heat to the surface, an operating fluid storage portion communicating with said hollow portion for storing an operating fluid, and a heating device for heating and evaporating said operating fluid; and
an operating fluid passage interconnecting said hollow portion and said operating fluid storage portion, at least a portion of said operating fluid passage lying above a surface of the operating fluid stored in said operating fluid storage portion being shaped to have an angle of inclination with respect to a horizontal plane.

2. A heat treatment apparatus as defined in claim 1, further comprising a cooling mechanism for cooling said operating fluid passage.

3. A heat treatment apparatus as defined in claim 2, wherein said operating fluid passage has a hydrophilic inner surface.

4. A heat treatment apparatus as defined in claim 3, wherein said operating fluid passage is formed of metal, with the inner surface treated by UV irradiation or blasting.

5. A heat treatment apparatus as defined in claim 2, wherein said cooling mechanism includes:
a plate surrounding said operating fluid passage;
a cooling fluid channel disposed in said plate; and
a cooling fluid source for supplying a cooling fluid to said channel.

6. A heat treatment apparatus as defined in claim 5, wherein said cooling fluid is air.

7. A heat treatment apparatus as defined in claim 5, wherein said cooling mechanism is arranged to cool said operating fluid passage constantly.
